(19) United States
(12) Patent Application Publication
(10) Pub. No.: US 2026/0171920 A1
(43) Pub. Date: Jun. 18, 2026

(54) FLYBACK CONVERTER

(71) Applicant: HANWHA SOLUTIONS CORPORATION, Seoul (KR)

(72) Inventor: Duk Hyeon YUN, Seoul (KR)

(21) Appl. No.: 19/334,910

(22) Filed: Sep. 21, 2025

(30) Foreign Application Priority Data
Dec. 17, 2024 (KR) 10-2024-0188558

(51) Int. Cl. H02M 3/335; H02J 3/32; H02J 3/46

(52) U.S. Cl. CPC H02M 3/33592; H02J 3/32; H02J 3/46; H02J 2101/24

(57) ABSTRACT

Provided is a flyback converter. A converter includes an input unit to which input voltage is applied, a switching unit configured to convert the input voltage into an alternating current (AC) voltage, a transformer comprising a primary side to which the AC voltage is applied and a secondary side from which an output voltage of the transformer is output, a driving signal generation unit configured to generate a driving signal for driving a synchronous rectifier, and an output unit configured to output an output voltage of the converter in case that driving current flows based on the driving signal.

### CROSS-REFERENCE TO RELATED APPLICATION

This application is based on and claims priority under 35 U.S.C. § 119 to Korean Patent Application No. 10-2024-0188558, filed on Dec. 17, 2024, in the Korean Intellectual Property Office, the disclosure of which is incorporated by reference herein in its entirety.

### BACKGROUND

### 1. Field

The present disclosure relates to a flyback converter.

### 2. Description of the Related Art

Converters receive an input voltage and convert the same into a user-desired output voltage. The converters may convert direct current (DC) power or DC power into alternating current (AC) power. Among the converters, a DC-DC converter may adjust DC power to supply power suitable for various circuits. An AC-DC converter may cause energy produced from a grid to be usable in a variety of electronic devices.

Meanwhile, a flyback converter is a type of DC-DC converter that has a relatively small number of components and operates stably and thus is widely used in small-capacity switching mode power supplies (SMPS).

### SUMMARY

The present disclosure aims to provide a flyback converter. The problem that the present disclosure aims to solve is not limited to the problems mentioned above, and other problems and advantages of the present disclosure that are not mentioned can be understood through the following description and can be understood more clearly by the examples of the present disclosure. In addition, it will be appreciated that the problems and advantages to be solved by the present disclosure may be realized by means and combinations thereof indicated in the claims.

According to a first aspect of the present disclosure, a converter includes an input unit to which an input voltage is applied, a switching unit configured to convert the input voltage into an alternating current (AC) voltage, a transformer including a primary side to which the AC voltage is applied and a secondary side from which an output voltage of the transformer is output, a driving signal generation unit configured to generate a driving signal for driving a synchronous rectifier, and an output unit configured to output an output voltage of the converter in case that driving current flows based on the driving signal, in which the driving signal generation unit is further configured to generate the driving signal based on the output voltage of the transformer and the output voltage of the converter.

According to a second aspect of the present disclosure, an energy storage device includes a plurality of battery cells and a converter including an input unit to which an input voltage is applied, a switching unit configured to convert the input voltage into an alternating current (AC) voltage, a transformer including a primary side to which the AC voltage is applied and a secondary side from which an output voltage of the transformer is output, a driving signal generation unit configured to generate a driving signal for driving a synchronous rectifier, and an output unit configured to output an output voltage of the converter in case that driving current flows based on the driving signal, in which the driving signal generation unit is further configured to generate the driving signal based on the output voltage of the transformer and the output voltage of the converter.

According to a third aspect of the present disclosure, a power supply system includes one or more photovoltaic modules configured to generate power, one or more devices respectively connected to the one or more photovoltaic modules, a grid configured to transmit power generated at a power plant to a power supply system or transmit power generated in the power supply system to outside, an energy storage device configured to receive and store power from the one or more photovoltaic modules and the grid, one or more loads, and a distribution device configured to provide electrical connection in the power supply system and control a flow of power, wherein the energy storage device includes a plurality of battery cells and a converter including an input unit to which an input voltage is applied, a switching unit configured to convert the input voltage into an alternating current (AC) voltage, a transformer including a primary side to which the AC voltage is applied and a secondary side from which an output voltage of the transformer is output, a driving signal generation unit configured to generate a driving signal for driving a synchronous rectifier, and an output unit configured to output an output voltage of the converter in case that driving current flows based on the driving signal, in which the driving signal generation unit is further configured to generate the driving signal based on the output voltage of the transformer and the output voltage of the converter.

In addition, another method and another system for implementing the present disclosure, and a computer-readable recording medium having stored therein a computer program for executing the method may be further provided.

Other aspects, features, advantages, and advantages other than those described above will become apparent from the following figures, claims, and the detailed description of the present disclosure.

### BRIEF DESCRIPTION OF THE DRAWINGS

The above and other aspects, features, and advantages of certain embodiments of the disclosure will be more apparent from the following description taken in conjunction with the accompanying drawings in which:

FIG. 1 is a circuit diagram of a converter according to an embodiment of the present disclosure;

FIG. 2 is a circuit diagram showing in detail a driving signal generation unit according to an embodiment of the present disclosure;

FIG. 3 is a circuit diagram showing in detail a high-pass filter according to an embodiment of the present disclosure;

FIG. 4 is a block diagram for describing a photovoltaic power generation system according to an embodiment of the present disclosure; and

FIG. 5 is a view for schematically describing a power supply system according to the present disclosure.

### DETAILED DESCRIPTION

Advantages and features of the present disclosure, and a method of achieving them will be apparent with reference to the embodiments described in detail in conjunction with the drawings. However, the present disclosure is not limited to the embodiments presented below, but may be implemented in various different forms, and should be understood to include all transformations, equivalents, and substitutes included in the spirit and technical scope of the present disclosure. Embodiments presented below are provided to complete the disclosure of the present disclosure and perfectly inform those of ordinary skill in the art of the category of the present disclosure. In describing the present disclosure, in case that it is determined that a detailed description of related known technologies may obscure the gist of the present disclosure, the detailed description thereof will be omitted.

The term used herein is used to describe particular embodiments, and is not intended to limit the present disclosure. Singular forms may include plural forms unless apparently indicated otherwise contextually. It should be understood that the term “include”, “have”, or the like used herein is to indicate the presence of features, numbers, steps, operations, elements, parts, or a combination thereof described in the specifications, and does not preclude the presence or addition of one or more other features, numbers, steps, operations, elements, parts, or a combination thereof.

Some embodiments of the present disclosure may be represented by functional block configurations and various processing steps. Some or all of the functional blocks may be implemented with various numbers of hardware and/or software configurations executing particular functions. In some embodiments, the functional blocks of the present disclosure may be implemented by one or more microprocessors or circuit configurations for certain functions. In some embodiments, functional blocks of the present disclosure may be implemented in various programming or scripting languages. Functional blocks may be implemented as algorithms running on one or more processors. The present disclosure may employ related art for electronic environment setting, signal processing, and/or data processing, etc. The term such as “mechanism”, “element”, “means”, or “configuration” may be used broadly and may not be limited to mechanical and physical configurations.

Additionally, connection lines or connection members between components shown in the drawings merely exemplify functional connections and/or physical or circuit connections. In an actual device, connections between components may be represented by various replaceable or additional functional connections, physical connections, or circuit connections.

Additionally, “activating” or “deactivating” a functional block or component of the present disclosure may mean performing or not performing an operation through turning a switch on/off. That is, in case that a function block or component is activated, it may mean that the switch of the function block or component is turned on and operates, thereby forming an electrical connection with the surrounding function blocks or components. On the other hand, in case that a function block or component is deactivated, it may mean that the switch of the function block or component is turned off and does not operate, thereby blocking the electrical connection with the surrounding function blocks or components.

Hereinafter, the present disclosure will be described in detail with reference to the attached drawings.

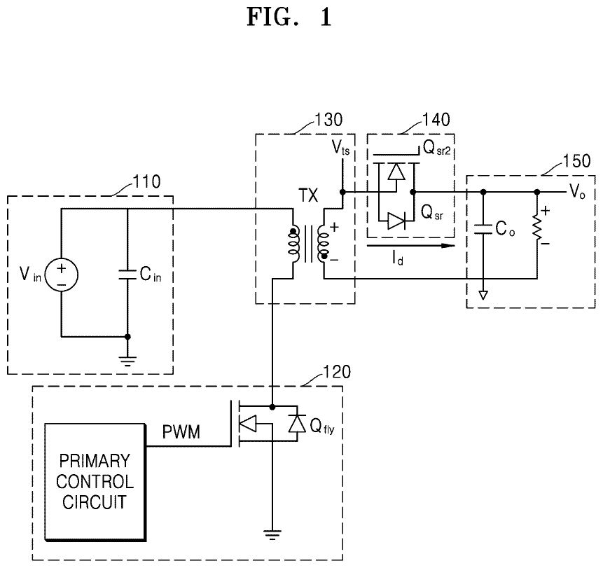

FIG. 1 is a circuit diagram of a converter according to an embodiment of the present disclosure.

Referring to FIG. 1, the converter may include an input unit 110, a switching unit 120, a transformer 130, a driving signal generation unit 140, and an output unit 150. The converter include a circuit provided on a primary side and a circuit provided on a secondary side around transformer 130. The circuit provided on the primary side may include the input unit 110 and the switching unit 120, and the circuit provided on the secondary side may include the driving signal generation unit 140 and the output unit 150.

In an embodiment, an input voltage may be applied through the input unit 110.

In an embodiment, the switching unit 120 may include a first switching element Q_{fly} and a primary control circuit. The switching unit 120 may convert an input voltage Vin into an AC voltage.

The first switching element Q_{fly} of the switching unit 120 may receive a pulse width modulation (PWM) signal from the primary control circuit. The first switching element Q_{fly} may be repeatedly turned on or off by the PWM signal. In case that the turning-on or turning-off of the first switching element Q_{fly} is repeated, the AC voltage may be applied to the primary side of the transformer 130.

In an embodiment, the primary control circuit of the switching unit 120 may be implemented as an integrated circuit, or may be implemented through integrated circuits that perform separate functions, such as a comparator, an amplifier, etc.

In an embodiment, the transformer 130 may transmit energy applied to the primary side of the transformer 130 to the secondary side. The transformer 130 may convert a voltage applied to the primary side of the transformer 130 into an output voltage Vₜₛ of the transformer 130, which is a voltage on the secondary side, based on a winding ratio of the transformer 130.

As described later, the driving signal generation unit 140 of the present disclosure may generate a driving signal based on the output voltage Vₜₛ of the transformer 130.

In an embodiment, the driving signal generation unit 140 may generate a synchronous rectifier driving signal which may be a signal for driving a synchronous rectifier. The turning-on or turning-off of a second switch Qₛᵣ, which is a synchronous rectifier, may be controlled by the driving signal generated by the driving signal generation unit 140.

In an embodiment, in case that the second switch Qₛᵣ is turned on by the driving signal generated by the driving signal generation unit 140, a driving current I_{d} may flow to the output unit 150. In case that the driving current I_{d} flows to the output unit 150, an output voltage Vₒ of the converter may be output.

The driving signal generation unit 140 according to an embodiment of the present disclosure may use the output voltage Vₒ of the converter as a command voltage.

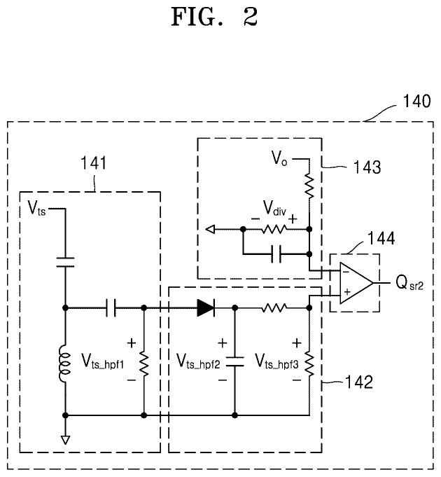

FIG. 2 is a circuit diagram showing in detail a driving signal generation unit according to an embodiment of the present disclosure.

In an embodiment, the driving signal generation unit 140 may include a circuit for generating a first comparison voltage and a circuit for generating a second comparison voltage in which the first comparison voltage and the second comparison voltage may be input to a comparator 144. In an embodiment, a part generating the first comparison voltage may include a high-pass filter 141 and a triangle-wave generation unit 142. In an embodiment, a part generating the second comparison voltage may include a voltage distribution unit 143. In the driving signal generation unit 140, the high-pass filter 141 may be a circuit that outputs a voltage of at least a preset frequency (e.g., a cutoff frequency) based on an input voltage, the triangle-wave generation unit 142 may be a circuit that generates a triangle wave based on the input voltage, and the voltage distribution unit 143 may be a circuit that distributes the input voltage to adjust a magnitude thereof.

As described later, the driving signal generation unit 140 of the present disclosure may generate a driving signal based on the output voltage Vₜₛ of the transformer 130.

In an embodiment, the output voltage Vis of the transformer 130 may be applied to the high-pass filter 141 included in the driving signal generation unit 140, and a first filtered voltage V_{ts_hpf1} may be output by the high-pass filter 141.

The high-pass filter 141 may include two capacitors, e.g., a first capacitor and a second capacitor, and one inductor. In an embodiment, a first terminal of the first capacitor of the high-pass filter 141 may be connected to the output voltage Vₜₛ of the transformer 130, and a second terminal of the first capacitor of the high-pass filter 141 may be connected to a first terminal of the inductor. In an embodiment, the first terminal of the inductor of the high-pass filter 141 may be connected to the second terminal of the first capacitor and a first terminal of the second capacitor, and a second terminal of the inductor of the high-pass filter 141 may be connected to ground. In an embodiment, the first terminal of the second capacitor of the high-pass filter 141 may be connected to the second terminal of the first capacitor and the first terminal of the inductor, and a second terminal of the second capacitor of the high-pass filter 141 may be connected to a load to which the first filtered voltage V_{ts_hpf1} is applied.

In an embodiment, the first filtered voltage V_{ts_hpf1} output by the high-pass filter 141 may be applied to the triangle-wave generation unit 142, and a third filtered voltage V_{ts_hpf3} may be output by the triangle-wave generation unit 142.

The triangle-wave generation unit 142 may include a rectifier, a capacitor, and two voltage distribution loads. In an embodiment, a first terminal of the rectifier of the triangle-wave generation unit 142 may be connected to an output terminal of the high-pass filter 141, and a second terminal of the rectifier of the triangle-wave generation unit 142 may be connected to a first terminal of the capacitor. The first filtered voltage V_{ts_hpf1} may be rectified by the rectifier of the triangle-wave generation unit 142 to generate a second filtered voltage V_{ts_hpf2}, and the second filtered voltage V_{ts_hpf2} may be applied to the capacitor of the triangle-wave generation unit 142. The second filtered voltage V_{ts_hpf2} may have a magnitude adjusted by the voltage distribution loads of the triangle-wave generation unit 142, and the second filtered voltage V_{ts_hpf2} having the adjusted magnitude may be the third filtered voltage V_{ts_hpf3}. The third filtered voltage V_{ts_hpf3} may be applied to the comparator 144 as the first comparison voltage.

As described above, the driving signal generation unit 140 according to an embodiment of the present disclosure may use the output voltage Vₒ of the converter as a command voltage.

In an embodiment, the output voltage Vₒ of the converter may be applied to the voltage distribution unit 143 included in the driving signal generation unit 140, and a voltage distributed by the voltage distribution unit 143 may be output. In an embodiment, the voltage distribution unit 143 may include two voltage distribution loads and one capacitor. The output voltage Vₒ of the converter may be adjusted to an appropriate magnitude by the voltage distribution unit 143. An output voltage V_{div} of the converter distributed by the voltage distribution unit 143 may be applied to the comparator 144 as the second comparison voltage.

In an embodiment, the comparator 144 may generate a second switch control signal Qₛᵣ₂ as an output of the driving signal generation unit 140 based on the first comparison voltage and the second comparison voltage. In some embodiments, based on the first comparison voltage being greater than or equal to the second comparison voltage, the comparator 144 may generate the second switch control signal Qₛᵣ₂ corresponding to a turn-on voltage. In some embodiments, based on the first comparison voltage being less than the second comparison voltage, the comparator 144 may generate the second switch control signal Qₛᵣ₂ corresponding to a turn-off voltage.

In an embodiment, a driving signal that is an output of the driving signal generation unit 140, i.e., the second switch control signal Qₛᵣ₂, may control the turning-on or turning-off of the second switch Qₛᵣ. In case that the second switch Qₛᵣ is turned on, the driving current I_{d} may flow to the output unit 150, and the output voltage Vₒ of the converter may be output.

A value of each element included in the driving signal generation unit 140 according to the present disclosure may be appropriately determined according to an environment in which the converter is used and the specifications of the product.

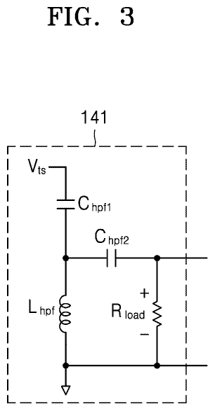

FIG. 3 is a circuit diagram showing in detail a high-pass filter according to an embodiment of the present disclosure.

As described above, the high-pass filter 141 may include two capacitors, e.g., a first capacitor and a second capacitor, and one inductor.

Referring to FIG. 3, a first capacitor C_{hpf1}, a second capacitor C_{hpf2}, an inductor L_{hpf}, and a load R_{load} of the high-pass filter 141 are shown in which the first filtered voltage V_{ts_hpf1} is applied to the load R_{load}.

Designing of the high-pass filter 141 may affect the shape of the triangle wave generated by the triangle-wave generation unit 142, such that it may be important to appropriately design the high-pass filter 141.

An inductance of the inductor L_{hpf} of the high-pass filter 141 may be determined according to Equation 1 below.

$${L}_{hpf} = \frac{1}{{{c}_{hpf 1} ( 2 π ( 2 {f}_{sw} ) )}^{2}} \qquad [ Equation 1 ]$$

In Equation 1, f_{sw} may mean a switching frequency of the converter. In some embodiments, f_{sw} may be set such that a natural frequency of the high-pass filter 141 is twice the switching frequency.

A capacitance of the first capacitor C_{hpf1} and a capacitance of the second capacitor C_{hpf2} may be equal to each other. This may be for phase compensation. This may be expressed as Equation 2 below.

$${C}_{hpf 1} = {C}_{hpf 2} \qquad [ Equation 2 ]$$

With respect to the cutoff frequency of the high-pass filter 141, a relationship between the capacitance of the second capacitor C_{hpf2}, a resistance of the load R_{load}, and the inductance of the inductor L_{hpf} may be suitably set. In particular, an impedance of the inductor L_{hpf} needs to be sufficiently greater than impedances of the second capacitor C_{hpf2} and the load R_{load}. In some embodiments, in case that the impedance of the inductor L_{hpf} is Za, and the impedances of the second capacitor C_{hpf2} and the load R_{load} are Z_{b}, they may be set as in Equation 3 below.

$$25 \leq \frac{{Z}_{a}}{{Z}_{b}} \qquad [ Equation 3 ]$$

Although not shown in FIG. 3, a capacitance of the capacitor included in the triangle-wave generation unit may be set such that a triangle wave of an appropriate shape may be generated based on the capacitance of the first capacitor C_{hpf1} because, for an excessively great capacitance of the capacitor, the ripple of the triangle wave is absorbed and a waveform of a smooth shape is generated. In some embodiments, in case that the capacitance of the capacitor included in the triangle-wave generation unit is Cₓ, Cₓ may be set as in Equation 3 below.

$${C}_{x} = \frac{{C}_{hpf 1}}{100} \qquad [ Equation 4 ]$$

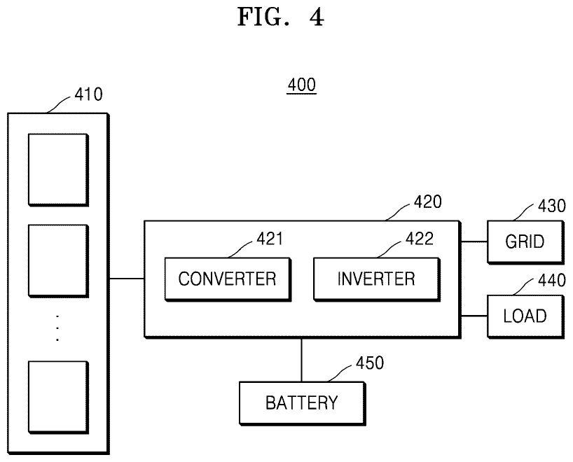

FIG. 4 is a block diagram for describing a photovoltaic power generation system according to an embodiment of the present disclosure.

Referring to FIG. 4, a photovoltaic power generation system 400 according to an embodiment may include one or more photovoltaic modules 410, a power conversion device 420, a grid 430, a load 440, and/or a power storage device 450.

The one or more photovoltaic modules 410 may produce electrical energy based on sunlight energy and may include a plurality of solar cells.

The power conversion device 420 may refer to a device that converts power generated by the one or more photovoltaic modules 410 and transmits the generated power to the grid 430, the load 440, etc. The power conversion device 420 may include a converter 421 and an inverter 422. The converter 421 included in the power conversion device 420 may be a DC-DC converter and may regulate power generated from the one or more photovoltaic modules 410. The inverter 422 included in the power conversion device 420 may convert DC power generated from the one or more photovoltaic modules 410 into AC power. Devices that may be included in the power conversion device 420 are not limited to the devices described above.

The grid 430 may refer to a system that transmits and distributes electric energy produced by the photovoltaic power generation system 400 or supplies external energy to the photovoltaic power generation system 400. The grid 430 may transmit electric energy produced at a power plant to the photovoltaic power generation system 400 or transmit surplus power generated by the photovoltaic power generation system 400 to the outside.

The load 440 may mean an object that consumes electricity produced by the photovoltaic power generation system 400. The load 440 may include home appliances such as a washing machine, a refrigerator, a television (TV), etc.

The power storage device 450 may receive and store power generated from the one or more photovoltaic modules 410. The power storage device 450 may include an energy storage system (ESS) capable of storing generated power and efficiently supplying power to the load 440 when the power is needed by the load 440.

In addition to the components shown in FIG. 4, the photovoltaic power generation system 400 may include any suitable components for operating the photovoltaic power generation system 400. In some embodiments, the photovoltaic power generation system 400 may include a connection section through which power moves within the photovoltaic power generation system 400, a distribution panel that distributes power within the photovoltaic power generation system 400, a monitoring device for monitoring the photovoltaic power generation system 400, etc.

As described above, the power conversion device 420 may include the converter 421 and the inverter 422.

The converter 421 of FIG. 4 may be the converter according to various embodiments described above with reference to FIGS. 1 to 3. The converter 421 may include a driving signal generation unit that generates a first voltage based on an output voltage of a transformer included in the converter, generates a second voltage based on the output voltage of the converter, and generates a driving signal for driving a synchronous rectifier based on the first voltage and the second voltage.

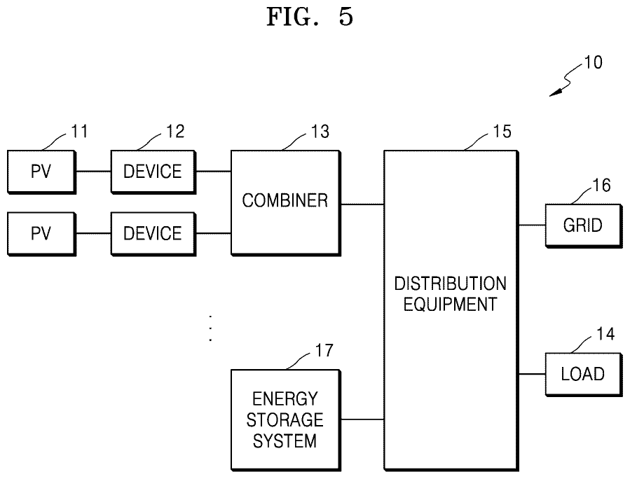

FIG. 5 is a view for schematically describing a power supply system according to the present disclosure.

Referring to FIG. 5, a power supply system 10 may include a photovoltaic module 11, a device 12, a load 14, and/or distribution equipment 15. The power supply system 10 may be connected to an external grid 16.

At least one photovoltaic module 11 may be installed on the roof or exterior wall of a building to generate power. A plurality of photovoltaic modules 11 may be connected to form a photovoltaic module array.

The photovoltaic module 11 may be connected to the device 12. In some embodiments, at least one device 12 may be connected to each photovoltaic module 11. In some embodiments, in case that one device 12 is connected to each photovoltaic module 11, the number of devices 12 constituting the power supply system 10 may be equal to the number of photovoltaic modules 11.

The device 12 may be a power conditioning system or power conversion system (PCS) that performs power conversion for power generated from the photovoltaic module 11. In some embodiments, the device 12 may perform selected conversion on the power generated from the photovoltaic module 11 and supply the converted power to other components of the power supply system 10 (e.g., the grid 16 and/or the load 14, etc.).

The device 12 may be a module level power electronics (MLPE) device. In some embodiments, the device 12 may be an optimizer or a micro inverter (MI).

In some embodiments, in case that the device 12 is an optimizer, the device 12 may regulate the power generated from the photovoltaic module 11 and output the regulated power to an inverter (e.g., a string inverter). Current converted by the inverter (e.g., direct current converted into alternating current) may be output to the grid 16 or the load 14.

In some embodiments, in case that the device 12 is a micro inverter, the device 12 may convert the power generated from the photovoltaic module 11 (e.g., convert direct current into alternating current). The current converted in the device 12 may be output to the grid 16 or the load 14.

Depending on a need, the power supply system 10 may further include a combiner 13. At least a part of the device 12 may be connected to the distribution equipment 15 through the combiner 13. In some embodiments, power output from a plurality of devices 12 may be combined into one output by the combiner 13 and supplied to the distribution equipment 15.

The device 12 and the distribution equipment 15 may be connected by a power path that does not include the combiner 13, and at least one device 12 may be connected to the distribution equipment 15 by a power path that does not include the combiner 13, and at least one other device 12 may be connected to the distribution equipment 15 through the combiner 13.

The combiner 13 may control voltage, current and/or power output from the device 12 according to a power supply state of the photovoltaic module 11, the device 12, and/or the grid 16, and set the operation mode of the combiner 13 to a diagnosis mode or a driving mode, etc.

The combiner 13 may include an energy management system (EMS) that controls the operation of the combiner 13. The EMS may control voltage, current and/or power supplied to or output from the device 12 according to a power supply state of the photovoltaic module 11, the device 12, and/or the grid 16, and set the operation mode of the combiner 13 to the diagnosis mode or the driving mode, etc.

The one or more loads 14 may refer to an object that is installed in an electricity receiver such as a house, commercial facility, factory, etc., and operates by receiving at least one of energy generated by the photovoltaic module 11, energy stored in an energy storage device 17, and/or energy supplied from the grid 16. In some embodiments, in case that the electricity receiver receiving power is a house, the load 14 may include home appliances such as a washing machine, a refrigerator, a TV, etc.

The grid 16 may include an infrastructure system for generating, transmitting, and distributing power. In some embodiments, the grid 16 may include the infrastructure system such as power plants, substations, power lines, etc. The grid 16 may transmit electric energy generated at a power plant to the power supply system 10 or transmit surplus power generated in the power supply system 10 to the outside of the power supply system 10.

In some embodiments, commercial power transmitted from the grid 16 through a power pole may be supplied to the power receiver through a transformer. The power supply system 10 may be implemented as an off-grid system that is not connected to the grid 16.

The power supply system 10 may further include at least one energy storage device 17. Depending on a need, the power supply system 10 may further include a plurality of energy storage devices 17. The energy storage device 17 may receive and store power generated by the photovoltaic module 11 and/or power transmitted from the grid 16. The energy storage device 17 may efficiently supply power by storing power and supplying power to the load 14 when the load 14 needs the power.

The energy storage device 17 may include a battery that stores power and a power conversion module. The battery may include a plurality of battery cells. The battery may include a battery management system (BMS) that monitors a state of charge (SOC), a state of health (SOH), voltage and/or current of the battery, performs diagnosis on the battery, and performs a safety function such as current cutoff, etc.

The energy storage device 17 according to an embodiment of the present disclosure may include the plurality of battery cells and the converter, and the converter may include an input unit to which an input voltage is applied, a switching unit configured to convert the input voltage into an alternating current (AC) voltage, a transformer including a primary side to which the AC voltage is applied and a secondary side from which an output voltage of the transformer is output, a driving signal generation unit configured to generate a driving signal for driving a synchronous rectifier, and an output unit configured to output an output voltage of the converter in case that driving current flows based on the driving signal. The driving signal generation unit may generate the driving signal based on the output voltage of the transformer and the output voltage of the converter.

The power conversion module may be a PCS that performs conversion between battery-side power and opposite-side power. In some embodiments, the PCS may convert between direct current on the battery side and alternating current on the opposite side. As an example, the PCS may include a bidirectional DC-DC converter that is connected to the battery to convert voltage, and a bidirectional inverter that connects the DC-DC converter to the outside of the energy storage device 17.

The energy storage device 17 may further include an EMS that controls the operation of the energy storage device 17. The EMS may control the voltage, current and/or power supplied to or output from the energy storage device 17 according to the power supply state of the battery and/or the grid 16, and may set the operation mode of the energy storage device 17 to the diagnosis mode or the driving mode, etc.

Depending on a need, the EMS coupled to a selected component of the power supply system 10 may not only control the operation of a selected component, but may also control operations of other components of the power supply system 10. For example, the EMS coupled to the combiner 13 or the EMS coupled to the energy storage device 17 may control both the operation of the combiner 13 and the operation of the energy storage device 17.

The distribution equipment 15 may provide electrical connection between components of the power supply system 10 and may control a power flow of the power supply system 10. In some embodiments, the distribution equipment 15 may electrically connect the photovoltaic module 11 and the load 14. In some embodiments, the distribution equipment 15 may be connected to the device 12 connected to the photovoltaic module 11 to electrically connect the photovoltaic module 11 to the load 14. Depending on a need, the distribution equipment 15 may be further connected to at least one of the energy storage device 17 and the grid 16.

In some embodiments, the distribution equipment 15 may be a distribution panel that distributes power within the power supply system 10. In some embodiments, the distribution equipment 15 may be a master service panel (MSP) that distributes the power generated from the photovoltaic module 11 to the load 14, etc.

In some embodiments, the distribution equipment 15 may be a primary controller that performs power distribution within the power supply system and controls each device 12. In some embodiments, the primary controller may include a switch, a circuit breaker, and a control unit. The switch, the circuit breaker and the control unit may each be implemented as an independent device, or at least some of the switch, the circuit breaker and the control unit may be included in a single device.

The primary controller may include a switch that controls electrical connection between components connected to the primary controller, such as the device 12 and the load 14. In some embodiments, the primary controller may include a relay, a power semiconductor, etc., that provides or blocks electrical connection to the device 12 and/or the energy storage device 17 depending on the operating state of each component of the power supply system 10.

The primary controller may perform rapid shutdown to stop power generation of the photovoltaic module 11 in an emergency situation such as overcurrent occurrence in the power supply system 10, etc. To this end, the primary controller may include a circuit breaker that blocks connection between the device 12 and the load 14.

The primary controller may include a control unit that generally controls the operation of the primary controller. In addition to the primary controller, the control unit may control the operations of other components of the power supply system 10, such as the device 12, the energy storage device 17, or the like.

The control unit may perform control on the voltage, current and/or power output from or supplied to each component according to the power supply state of the photovoltaic module 11, the device 12, the combiner 13, the load 14, the grid 16 and/or the energy storage device 17. The control unit may set the operation mode of the primary controller, the device 12 and/or the energy storage device 17 to the diagnosis mode, the driving mode, etc.

In some embodiments, the control unit may control the photovoltaic module 11, the device 12, the combiner 13 and/or the energy storage device 17, based on the state of the power supply system 10. In some embodiments, the control unit may control other components of the power supply system 10 by causing the primary controller to communicate with other components of the power supply system 10, e.g., the device 12, etc. Communication between the primary controller and other components of the power supply system 10 may be performed using power line communication (PLC), but the present disclosure is not limited thereto.

In some embodiments, the control unit may control the device 12 according to the power generation state of the photovoltaic module 11. In some embodiments, the primary controller may receive a control command from a server that monitors the power generation state of the photovoltaic module 11, and the control unit may control the device 12 according to the control command.

The primary controller may supply power to at least a part of the load 14 in case that power supply from the grid 16 is not smooth (e.g., in an off-grid situation, etc.). In some embodiments, in case that power supply from the grid 16 is not smooth, the primary controller may preferentially supply power generated from the photovoltaic module 11 and/or power stored in the energy storage device 17 to a backup load that has a relatively high need for stable power supply.

The power supply system 10 may further include an auxiliary power generation device (e.g., a diesel generator, etc.) that generates power in a separate manner other than photovoltaic power generation. In some embodiments, the auxiliary power generation device may be further connected to the distribution equipment 15. In case that the primary controller may not be able to correspond to a backup load merely with the photovoltaic module 11 and the energy storage device 17 due to environmental factors such as a time zone or weather, the primary controller may supply the power generated by the auxiliary power generation device to the backup load.

The control unit may be implemented by at least one processor. The processor may process a command of a computer program by performing basic arithmetic, logic, and input/output operations. The command may be provided from an internal memory of the primary controller or from an external device. The processor may generally control operations of other components included in the primary controller.

The processor may perform at least some of data analysis, processing, and result information generation for performing the above-described operations using at least one of machine learning, a neural network, or a deep learning algorithm as a rule-based or artificial intelligence algorithm. Examples of neural networks may include architecture-based neural network models such as a convolutional neural network (CNN), a deep neural network (DNN), and a recurrent neural network (RNN).

In some embodiments, the processor may be implemented as an array of a plurality of logic gates, or may be implemented as a combination of a general-purpose microprocessor and a memory storing a program executable on the microprocessor. In some embodiments, a processor may include a general purpose processor, a central processing unit (CPU), a microprocessor, a digital signal processor (DSP), a controller, a microcontroller, a state machine, etc.

In some environments, the processor may include an application specific integrated circuit (ASIC), a programmable logic device (PLD), a field programmable gate array (FPGA), etc. In some embodiments, the processor may refer to a combination of a DSP and a microprocessor, a combination of a plurality of microprocessors, a combination of one or more microprocessors combined with a DSP core, or a combination of processing devices such as any combination of other such components.

The energy storage device 17 shown in FIG. 5 may include the converter according to various embodiments described above with reference to FIGS. 1 to 3. The converter may include an input unit to which an input voltage is applied, a switching unit that converts the input voltage into an AC voltage, a transformer including a primary side to which the AC voltage is applied and a secondary side from which an output voltage of the transformer is output, a driving signal generation unit that generates a driving signal for driving a synchronous rectifier, and an output unit that outputs an output voltage of the converter in case that driving current flows based on the driving signal, in which the driving signal generation unit may generate the driving signal based on the output voltage of the transformer and the output voltage of the converter.

By combining at least some of the components described above, the power supply system 10 may be implemented in various forms.

The converter according to the present disclosure may be used as being included in the photovoltaic power generation system or the power supply system, as described above with reference to FIGS. 4 and 5, but its use is not necessarily limited to the foregoing description. In some embodiments, the converter according to the present disclosure may be used in vehicles, portable electronic devices like smartphones, power generation systems other than photovoltaic power generation systems, communication devices such as base stations or servers, etc.

According to various embodiments of the present disclosure, output may be maintained and heat generation may be suppressed without a significant increase in a physical area occupied by a circuit, thereby comprehensively improving power density and satisfying required specifications.

The use of all examples or exemplary terms (for example, etc.) in the present disclosure are to simply describe the present disclosure in detail, and unless the range of the present disclosure is not limited by the examples or the exemplary terms unless limited by the claims. It may be understood by those of ordinary skill in the art that various modifications, combinations, and changes may be made according to design conditions and factors within the scope of the appended claims or equivalents thereof.

Thus, the spirit of the present disclosure should not be determined by being limited to the above-described embodiments, and not only the claims to be described later, but also any range equivalent to or equivalently changed from the claims falls within the scope of the spirit of the present disclosure.

What is claimed is:

1. A converter comprising:
an input unit to which input voltage is applied;
a switching unit configured to convert the input voltage into an alternating current (AC) voltage;
a transformer comprising a primary side to which the AC voltage is applied and a secondary side from which an output voltage of the transformer is output;
a driving signal generation unit configured to generate a driving signal for driving a synchronous rectifier; and
an output unit configured to output an output voltage of the converter in case that driving current flows based on the driving signal,
wherein the driving signal generation unit is further configured to generate the driving signal based on the output voltage of the transformer and the output voltage of the converter.

2. The converter of claim 1, wherein the driving signal generation unit is further configured to:
generate a first voltage based on the output voltage of the transformer;
generate a second voltage based on the output voltage of the converter; and
generate the driving signal, based on the first voltage and the second voltage.

3. The converter of claim 2, wherein the driving signal generation unit comprises a first voltage generation unit configured to generate the first voltage, and
the first voltage generation unit comprises:
a high-pass filter to which the output voltage of the transformer is applied; and
a triangle-wave generation unit to which an output voltage of the high-pass filter is applied.

4. The converter of claim 2, wherein the driving signal generation unit comprises a second voltage generation unit configured to generate the second voltage, and the second voltage generation unit comprises a voltage distribution unit configured to distribute the output voltage of the converter to be applied.

5. The converter of claim 2, wherein the driving signal generation unit comprises a comparator to which the first voltage and the second voltage are applied.

6. The converter of claim 1, wherein the switching unit comprises:
a primary control circuit; and
a switching element controlled to be turned on or off based on a signal received from the primary control circuit.

7. An energy storage device comprising:
a plurality of battery cells; and
a converter, the converter comprising:
an input unit to which input voltage is applied;
a switching unit configured to convert the input voltage into an alternating current (AC) voltage;
a transformer comprising a primary side to which the AC voltage is applied and a secondary side from which an output voltage of the transformer is output;
a driving signal generation unit configured to generate a driving signal for driving a synchronous rectifier; and
an output unit configured to output an output voltage of the converter in case that driving current flows based on the driving signal,
wherein the driving signal generation unit is further configured to generate the driving signal based on the output voltage of the transformer and the output voltage of the converter.

8. The energy storage device of claim 7, wherein the driving signal generation unit is further configured to:
generate a first voltage based on the output voltage of the transformer;
generate a second voltage based on the output voltage of the converter; and
generate the driving signal, based on the first voltage and the second voltage.

9. The energy storage device of claim 8, wherein the driving signal generation unit comprises a first voltage generation unit configured to generate the first voltage, and
the first voltage generation unit comprises:
a high-pass filter to which the output voltage of the transformer is applied; and
a triangle-wave generation unit to which an output voltage of the high-pass filter is applied.

10. The energy storage device of claim 8, wherein the driving signal generation unit comprises a second voltage generation unit configured to generate the second voltage, and the second voltage generation unit comprises a voltage distribution unit configured to distribute the output voltage of the converter to be applied.

11. The energy storage device of claim 8, wherein the driving signal generation unit comprises a comparator to which the first voltage and the second voltage are applied.

12. The energy storage device of claim 7, wherein the switching unit comprises:
a primary control circuit; and
a switching element controlled to be turned on or off based on a signal received from the primary control circuit.

13. A power supply system comprising:
one or more photovoltaic modules configured to generate power;
one or more devices respectively connected to the one or more photovoltaic modules;
a grid configured to transmit power generated at a power plant to a power supply system or transmit power generated in the power supply system to outside;
an energy storage device configured to receive and store power from the one or more photovoltaic modules and the grid;
one or more loads; and
a distribution device configured to provide electrical connection in the power supply system and control a flow of power,
wherein the energy storage device comprises a plurality of battery cells and a converter, the converter comprising:
an input unit to which an input voltage is applied;
a switching unit configured to convert the input voltage into an alternating current (AC) voltage;
a transformer comprising a primary side to which the AC voltage is applied and a secondary side from which an output voltage of the transformer is output;
a driving signal generation unit configured to generate a driving signal for driving a synchronous rectifier; and
an output unit configured to output an output voltage of the converter in case that driving current flows based on the driving signal, and
the driving signal generation unit is further configured to generate the driving signal based on the output voltage of the transformer and the output voltage of the converter.

14. The power supply system of claim 13, wherein the driving signal generation unit is further configured to:
generate a first voltage based on the output voltage of the transformer;
generate a second voltage based on the output voltage of the converter; and
generate the driving signal, based on the first voltage and the second voltage.

15. The power supply system of claim 14, wherein the driving signal generation unit comprises a first voltage generation unit configured to generate the first voltage, and
the first voltage generation unit comprises:
a high-pass filter to which the output voltage of the transformer is applied; and
a triangle-wave generation unit to which an output voltage of the high-pass filter is applied.

16. The power supply system of claim 14, wherein the driving signal generation unit comprises a second voltage generation unit configured to generate the second voltage, and the second voltage generation unit comprises a voltage distribution unit configured to distribute the output voltage of the converter to be applied.

17. The power supply system of claim 14, wherein the driving signal generation unit comprises a comparator to which the first voltage and the second voltage are applied.

18. The power supply system of claim 13, wherein the switching unit comprises:
a primary control circuit; and
a switching element controlled to be turned on or off based on a signal received from the primary control circuit.
